(19) United States
(12) Patent Application Publication
(10) Pub. No.: US 2012/0105316 A1
(43) Pub. Date: May 3, 2012

(54) Display Apparatus

(75) Inventors: Yutaka KITAMORI, Osaka (JP); Yoshinobu SUZUKAWA, Osaka (JP)

(73) Assignee: SANYO ELECTRIC CO., LTD., Osaka (JP)

(21) Appl. No.: 13/347,605

(22) Filed: Jan. 10, 2012

Related U.S. Application Data
(63) Continuation-in-part of application No. PCT/JP2010/067056, filed on Sep. 30, 2010.

(30) Foreign Application Priority Data
Oct. 1, 2009 (JP) 2009-229748

(51) Int. Cl. G09G 5/00; H04N 5/222

(52) U.S. Cl. 345/156; 348/333.01; 348/E05.022

(57) ABSTRACT

The display apparatus has a displaying unit which displays an image, a first specifying unit which specifies direction of the person in the image captured by a plurality of imaging apparatuses arranged on different positions; a second specifying unit which specifies one of the plurality of imaging apparatuses for capturing and for displaying an image, in accordance with direction instructed by user and the direction specified by the first specifying unit.

### CROSS-REFERENCE TO RELATED APPLICATIONS

This application is a continuation-in-part application of Patent Cooperation Treaty Patent Application No. PCT/JP 2010/067056 (filed on Sep. 30, 2010), which claims priority from Japanese patent application JP 2009-229748 (filed on Oct. 1, 2009). All of which are hereby incorporated by reference herein.

### BACKGROUND OF THE INVENTION

1. Field of the Invention

The present invention relates to a display apparatus which displays image captured by camera. Specifically, the image includes a person as a photographic subject.

2. Description of the Related Art

In people's daily life, mirror is used in order to check his or her appearance visually.

In JP2002-290964A a TV-monitor employing the cameras in its both side is disclose. By displaying an image captured by the camera on the monitor, the monitor can be utilized as a mirror.

The inventor has considered that it will be convenient if such monitor can also display a person's back shot.

### SUMMARY OF THE INVENTION

According to one aspect of the present invention, a display apparatus comprises a displaying unit which displays an image, a first specifying unit which specifies direction of the person in the image captured by a plurality of imaging apparatuses arranged on different positions; a second specifying unit which specifies one of the plurality of imaging apparatuses for capturing and for displaying an image, in accordance with direction instructed by user and the direction specified by the first specifying unit.

According to another aspect of the present invention, A display apparatus comprises a displaying unit; an imaging unit arranged in the neighborhood of the display unit; a specifying unit which specifies direction of the person in the image captured by the imaging unit, and a display controlling unit which controls the captured image to be displayed in display by the first mode or the second mode, wherein in the first mode the image is displayed in real-time, and in the second mode the image is displayed in non real-time, the display controlling unit switches the between the first and the second mode depending on the position of the remote controller the user is holding.

### DESCRIPTION OF THE DRAWINGS

FIG. 1 illustrates a front view of display apparatus 1.

FIG. 2 is an upper view showing a spatial relation between display apparatus 1 and a photographic subject.

FIG. 3 is a side view showing a spatial relation between display apparatus 1 and a photographic subject.

FIG. 4 is a block diagram showing the electric circuit of display apparatus 1.

FIG. 5 is a flowchart showing image capturing process and image recording process executed by display apparatus 1.

FIG. 6 shows information recorded in the memory 16.

FIG. 7 is a flowchart showing image displaying process executed by display apparatus 1.

FIG. 8 shows how button 30 is displayed on display 14.

### DESCRIPTION OF THE PREFERRED EMBODIMENTS

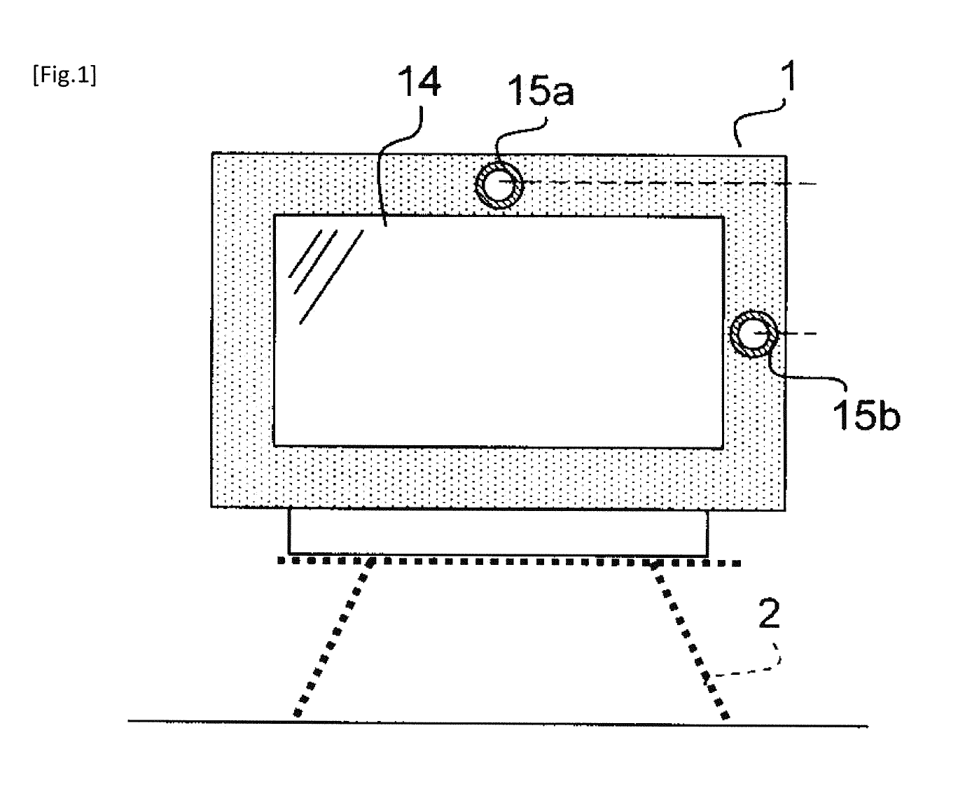

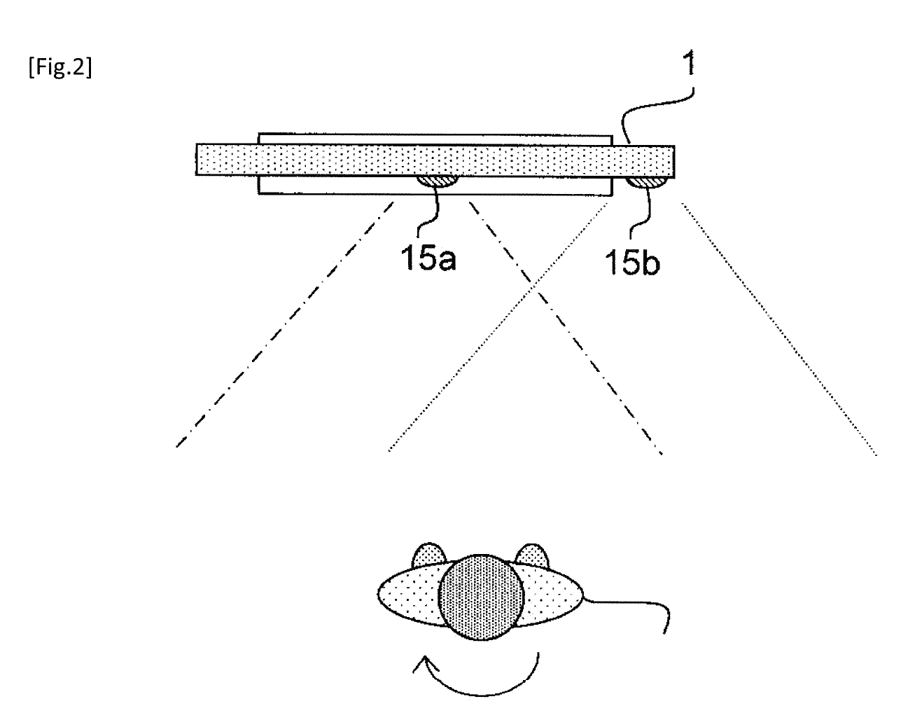

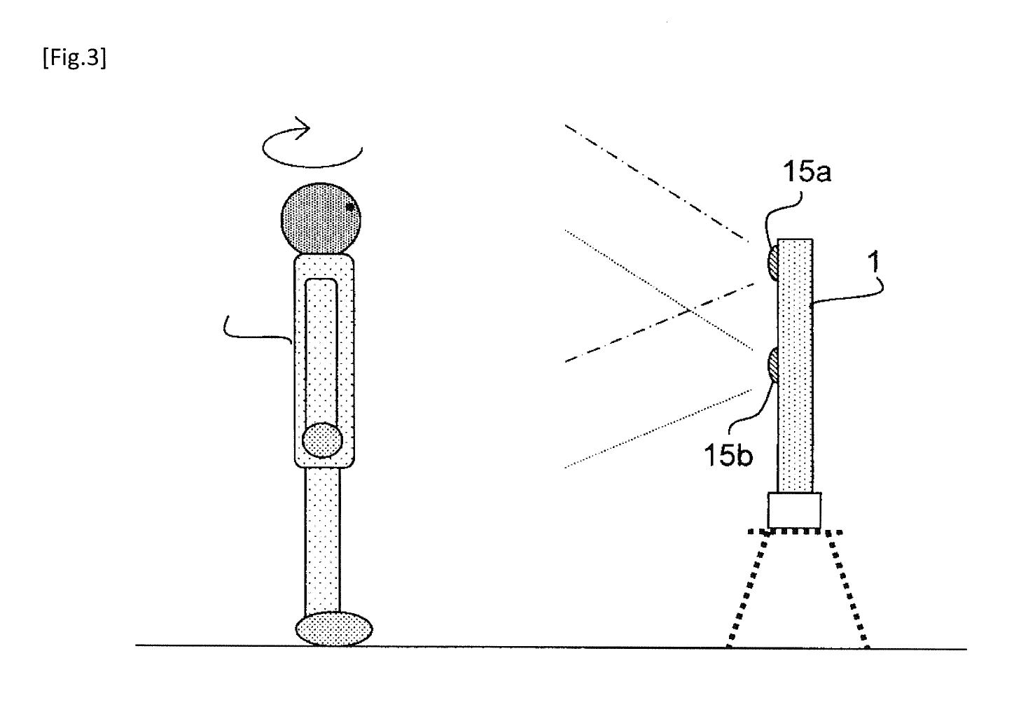

FIG. 1 illustrates a front view of display apparatus 1 of the present embodiment. In the apparatus 1, a display 14 constituted by PDP (Plasma Display Panel) or LCD (Liquid Crystal Display) panel is arranged at the front side. Typically, the apparatus 1 is installed on a stand 2. The first camera 15a and the second camera 15b are arranged in the peripheral portion of the display 14 so that it can capture the person who is in the front side of a display 14 as a photographic subject (see FIG. 2 and FIG. 3). The camera 15a is arranged on the upper side of the display 14, and the camera 15b is arranged on the right-hand side of the display 14.

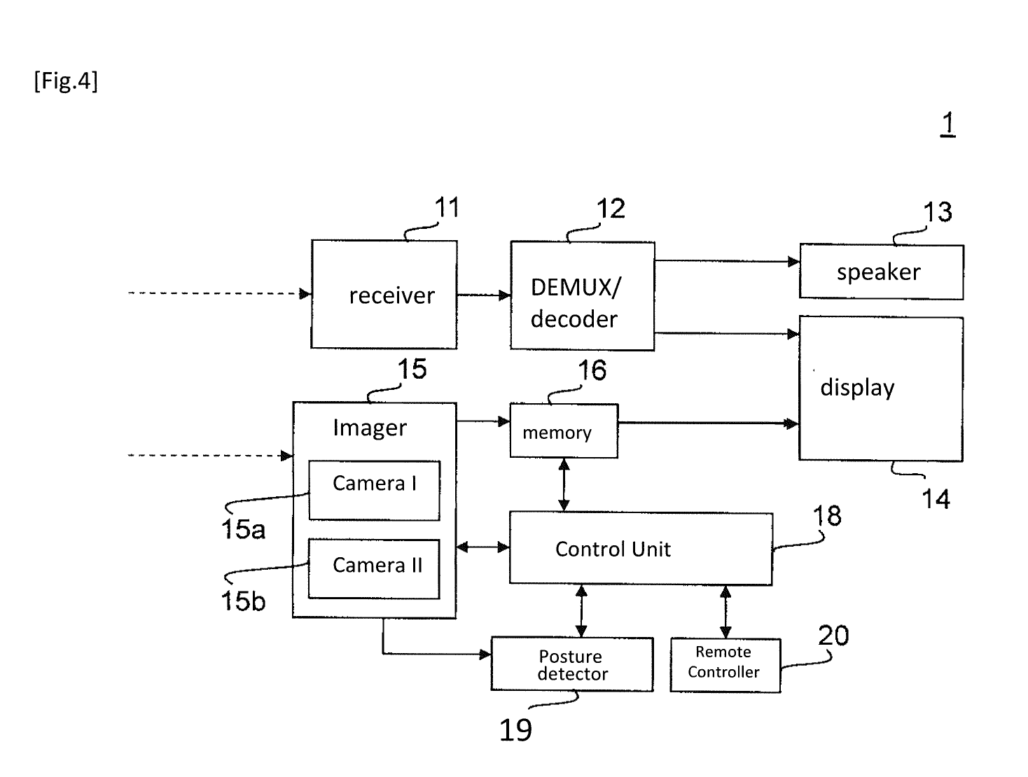

FIG. 4 is a block diagram showing the electric circuit of display apparatus 1. The display apparatus 1 has a broadcast signal receiver 11, a broadcast signal-processing unit (DEMUX/Decoder) 12, a speaker 13, a display 14, an imager 15, a memory 16, a control unit 18, a posture detector 19, and a remote controller.

The broadcast signal receiver 11 includes an antenna which receives a broadcast signal, and a tuner which performs tuning.

The broadcast signal-processing unit 12 includes a DEMUX which extracts image signal and audio signal from the signal (MPEG2-TS signal, for example) tuned by the tuner, and a decoder which decodes image and audio signal extracted by the DEMUX. The decoded image signal is transmitted to the display 14, and the decoded audio signal is transmitted to the speaker 13.

The imager 15 includes cameras 15a and 15b described above. Image data captured by the imager 15 is output to both memory 16 and posture detector 19. The reason the image is output to both of them is in order to process recording and posture detection simultaneously.

The memory 16 is constituted by the flash memory, for example, and stores or temporally memorizes captured image data transmitted from the imager 15.

The control unit 18 is constituted by CPU, for example, control of each part (or unit) in the display apparatus 1. The control unit 18 further controls so as to display the image data stored in the memory 17 on the display 14.

The operating unit 20 is remote controller in this example, and accepts an input from user. The inputting information is transmitted to the control unit 18. The remote controller may comprise gyroscope sensor inside for detecting direction.

The posture detector 19 detects direction of a photographic subject (i.e. person in front of the camera). As for detecting, following methods can be applied.

### (Method 1)

The apparatus may employ an image database having an image data of person with various postures. For example, person's image who is facing front, left, back, or right may be stored in the database. Then, by comparing the captured image with the image in the database (for example, compare by pattern matching), the posture of the person is estimated.

### (Method 2)

When there are two or more persons in front of the display apparatus 1, first, the target person who should be captured (or pursued) is specified from the image captured by the imager 15. For example, the target person may be determined by the area size of the face portion in the image. Then, by pursuing the motion of the person from video image, or continuously captured still image, person's posture is estimated.

### (Method 3)

This method assumes that the user is holding remote controller in his or her hand. First, the target person is determined using a method as described in above method-2. Next, by utilizing the information detected by the gyroscope sensor inside the remote controller in the user's hand, the posture of the target person is determined.

### (Process Performed by Display Apparatus 1)

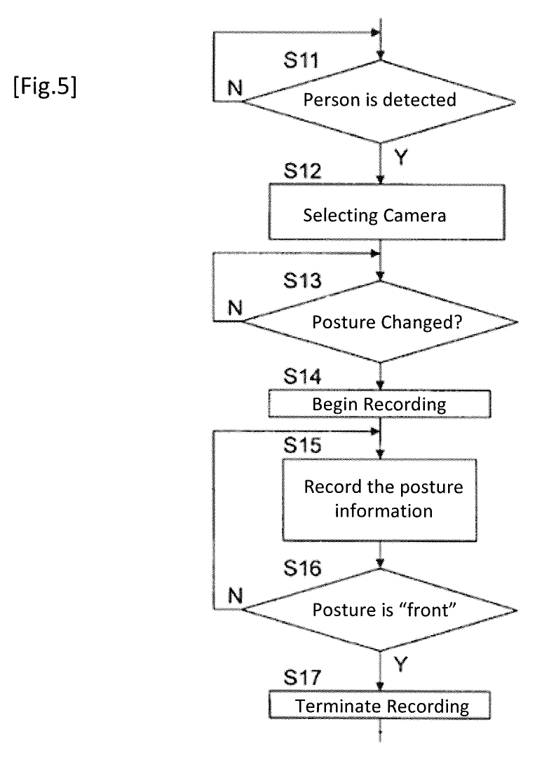

The process which the display apparatus 1 performs is explained. First, with reference to the flow chart of FIG. 5, the content of the image capturing process and the image recording process explained.

The control unit 18 controls the first camera 15a and the second camera 15b so as to capture image. Then the control unit 18 (or it may be performed by posture detector 17) analyzes the images captured by both cameras, and then detects if one of the camera has captured a person's face (Step S11).

When a person's face is contained in the image captured by one of the cameras, this camera is utilized in the following process (or steps in the flowchart). If the images captured by both of the cameras include person's face, then, the utilizing camera is determined based on area size of the face in the image or eye-gazing direction. The camera which captured person's face in the center portion of its captured image may be selected as well.

When a person's face is detected, a message such as “a face is detected” may be displayed on the display 14.

Then the posture detector 19 monitors whether the posture of the person (for example, the direction of the person's face) has changed based on the above described three methods (Step S13).

When the control unit 18 detects that the posture of the person has changed (Yes in Step S13), it controls so that the captured image is recorded on the memory 16. Then, the captured image is kept recorded until the direction of the person's face faces front (Step S15).

During the process of this step S15, the posture detector 19 detects the direction of the person based on one of three methods described above. The posture information in the captured image is also recorded on the memory 16.

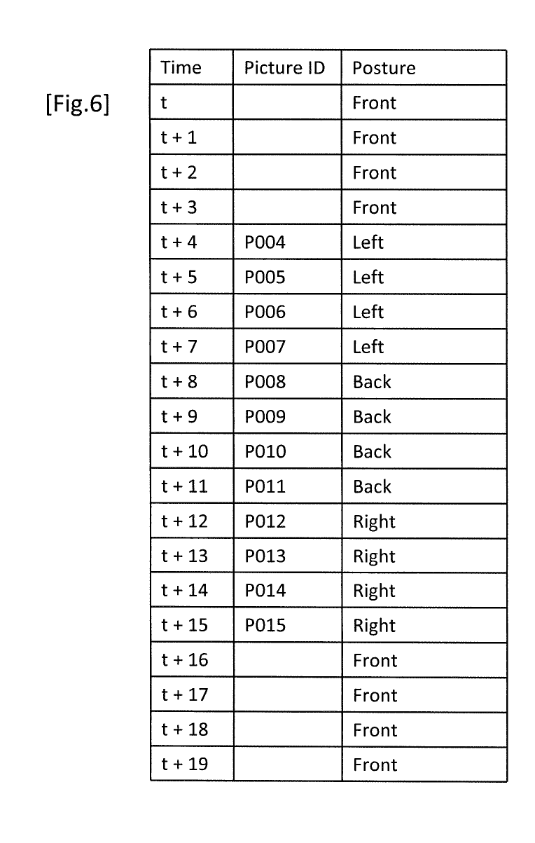

FIG. 6 shows the information recorded on the memory 16. Here, images are recorded on the memory 16 by a predetermined interval (for example, by 1-second interval). In this example, since the posture of the person in images captured during time t to t+3 is “front”, the captured images are not recorded on the memory 16 (note that the Picture ID is blank in the table). The images captured between time t+4 to t+18 are recorded on the memory 16 because the posture of the person is not “front”.

For example, the image captured at time t+4 is recorded as a image having an ID “P004.” Further, the posture information “left” is recorded together on the table.

The images recorded during the time t+8 to t+14 are recorded as images having IDs “P008” to “P014”, as images of “back” posture of the person.

The images recorded during the time t+15 to t+19 are recorded as images having IDs “P015” to “P019”, as images of “right” posture of the person.

When it is detected by the posture detector 19 that direction of the person gets back to the “front” (yes in Step S16), the control unit 18 terminates the recording of the captured images (Step S17). Then, the process goes back to Step S11 again.

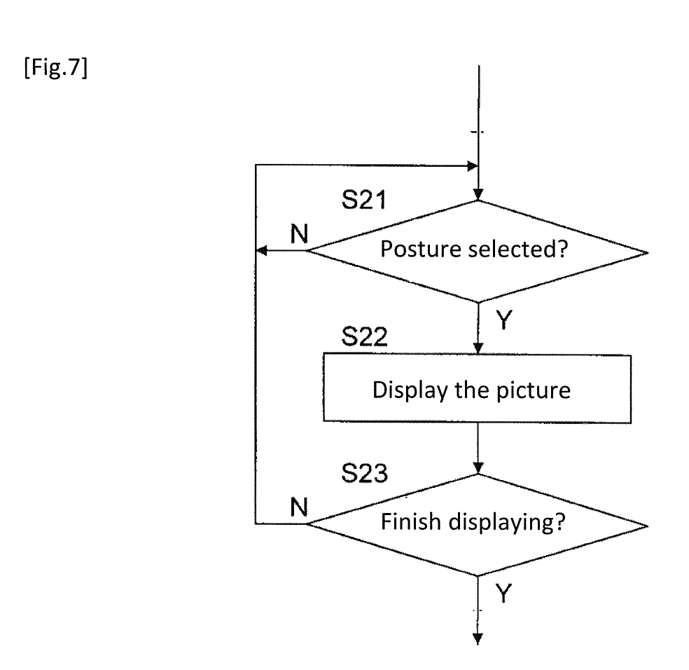

Next, with reference to the flowchart of FIG. 7, the image displaying process executed by the display apparatus 1 performs is discussed. First, when the user instructed to display the captured images, the process shown in the figure begins.

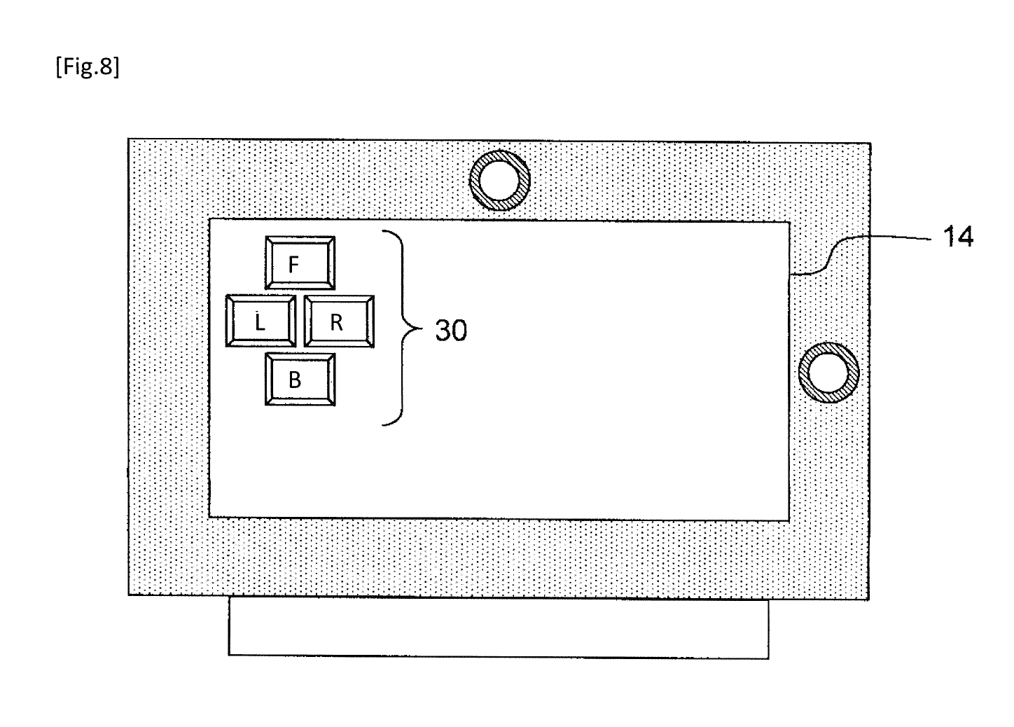

First, the control unit 18 receives information (i.e. posture or direction information) instructed by the user (Step S21). During this step, four buttons (or icons) 30 are displayed on display 14 as shown in FIG. 8. The user instructs the posture by selecting one of the buttons using remote controller 20. For example, if the user wants to see his backward view, then he should select “back” button.

When the direction is instructed (yes in Step S21), the control unit 18 search the image which conforms to the user's instruction from the memory 16. If the user selects “back”, the image corresponding to “back” posture (P009, for example, see FIG. 6) is displayed. Thereby, the user can check see his backward view. Similarly, the corresponding image recorded on the memory 16 is displayed when user selects “left” or “right”. When the user selects “front”, the captured image is not recorded on memory 16 as described in the flowchart of FIG. 5. In this case, the real-time image captured by imager 15 is displayed on the display 14.

The displaying images may not only be a still image as in the above example, but also it may be a moving image.

The images displayed on the display 14 are not the real-time images, but the images captured by the camera beforehand. However, when user wants to check his posture (his dress or his hairstyle etc.) it may not always necessary to have a real-time captured image. An image which was captured several seconds ago should satisfy user's requirement.

In the above example, the image captured by one of the cameras 15a and 15b is recorded on the memory 16. However, the images captured by both cameras may be recorded on the memory 16.

Further, as described on FIG. 4, the display apparatus 1 also functions as an ordinal television set. Thus, the user can utilize the apparatus 1 mainly as a television and occasionally as a mirror.

When a user ends displaying the captured images, the user can instruct to delete images recorded on memory 18. For example, if the display apparatus 1 is the apparatus shared by many people, the recorded images may be viewed by unspecified persons. Thus, if user does not want other person to see his (or her) images, the user can instruct to delete the recorded images on memory 18. The images may be deleted when there is no access to the image (i.e. playback instruction) for predetermined time, or may be deleted when predetermined period has elapsed from the recording time. The image recorded on the memory 18 may be accessible (displayable) only when a predetermined password is entered.

In the flow chart of FIG. 5 and FIG. 7, it is described that the imager 15 captures image full-time. However, the imager 15 may capture image only when instructed from the user. And, the images recorded on the memory 18 may be deleted when there is an instruction from the user to finish capturing the image.

The embodiment of the present invention is described as above. However, the scope of the present invention is not limited thereto, and the present invention may be implemented by being subjected to various modifications without departing from the gist of the present invention.

What is claimed is:

1. A display apparatus comprising:
a displaying unit which displays an image,
a first specifying unit which specifies direction of the person in the image captured by a plurality of imaging apparatuses arranged on different positions;
a second specifying unit which specifies one of the plurality of imaging apparatuses for capturing and for displaying an image, in accordance with direction instructed by user and the direction specified by the first specifying unit.

2. The apparatus according to claim 1, further comprising:
a television broadcast receiver which receives a television broadcasting program and acquires the image information of the television program, wherein,
said display is also utilized for displaying the image information of the television program.

3. A display apparatus comprising:
a displaying unit;
an imaging unit arranged in the neighborhood of the display unit;
a specifying unit which specifies direction of the person in the image captured by the imaging unit, and
a display controlling unit which controls the captured image to be displayed in display by the first mode or the second mode, wherein in the first mode the image is displayed in real-time, and in the second mode the image is displayed in non real-time,
the display controlling unit switches the between the first and the second mode depending on the position of the remote controller the user is holding.
